(19) United States
(12) Patent Application Publication
(10) Pub. No.: US 2021/0137074 A1
(43) Pub. Date: May 13, 2021

(54) MULTI-PANEL SCRATCHING SYSTEM FOR PETS

(71) Applicant: Jeffrey Goronkin, Schenectady, NY (US)

(72) Inventor: Jeffrey Goronkin, Schenectady, NY (US)

(21) Appl. No.: 16/948,722

(22) Filed: Sep. 30, 2020

Related U.S. Application Data
(60) Provisional application No. 62/933,017, filed on Nov. 8, 2019.

(51) Int. Cl. A01K 15/02

(52) U.S. Cl. CPC A01K 15/024

(57) ABSTRACT

A multi-panel scratching system for pets. The system includes a support structure transversely extending from a base structure. A plurality of releasable fasteners may be spaced apart along the support structure. A plurality of scratching panels may be provided, each scratching panel also having releasable fasteners to removably and selectively connect to the support structure. Each scratching panel may provide a flat face, a grooved face, a cushioned face, a carpeted face or a combination thereof for pets to scratch.

### CROSS-REFERENCE TO RELATED APPLICATION

This application claims the benefit of priority of U.S. provisional application No. 62/933,017, filed 8 Nov. 2019, the contents of which are herein incorporated by reference.

### BACKGROUND OF THE INVENTION

The present invention relates to pet accessories and, more particularly, a customizable, multi-panel scratching system for pets, especially cats.

Cat scratching is a destructive act that can destroy a number of materials such as, but not limited to, wood furniture, cabinets, carpet, sofas and fabric.

Current cat scratching products on the market, such as carpet covered scratching posts or cardboard, are not effective in blocking household items from cats scratching, distracting the cat from scratching on them, or being a satisfactory substitute for the household item the cat has become accustomed to scratching.

Existing products are not intended to block the variety of household items. Furthermore, the surface of existing products are not effective substitutes because they cannot be customized to match the surface of the items pet owners are trying to protect from scratching. For example, if a cat prefers to scratch on wood, the cat will continue to scratch on wood surfaces in the home even if a carpet scratching post is positioned in close proximity to the wood surface.

As can be seen, there is a need for a customizable, multi-panel scratching system for cats. The scratching system embodied in the present invention may be customizable and so capable of mimicking a variety of scratching surfaces and so may be placed in front of or in close proximity of household items cats like to scratch to prevent the cat from causing damage to household items. As a result, the household items are increasingly protected as the cats become more accustomed to scratching on the present invention instead of the household item.

Each panel of the present invention can have a surface such as wood, fabric, or carpet to meet the scratching preferences of a cat. The present invention is the only product with a multi-panel system that resembles a ladder. Each panel on the system can have a unique surface and can be removed quickly and be replaced by other panels. The panel system is an improvement over other products in the field because it allows the pet owner to customize the scratching surface at any time and for any reason.

### SUMMARY OF THE INVENTION

In one aspect of the present invention, scratching panel system including the following: a support structure; a plurality of panels, each panel having a rear face and a front face; the rear face adapted to selectively and removably connect along the support structure; the front face including the following: (a) a planar face; (b) a grooved face; (c) a cushioned face; (d) a carpeted face; or (e) a combination of two or more of (a) through (d), wherein the plurality of panels comprises at least two of (a) through (d).

In another aspect of the present invention, the scratching panel system including: a support structure, wherein the support structure is elongated having a length at least twice that of a width; a plurality of wood panels, each panel having a rear face and a front face; the rear face adapted to selectively and removably connect along the support structure; the front face including the following: (a) a planar face; (b) a grooved face; (c) a cushioned face; (d) a carpeted face; or (e) a combination of two or more of (a) through (d), wherein the plurality of wood panels comprises at least two of (a) through (d) and at least one (e); a base connected relative to the support structure at an angle of incidence between 65 and 35 degrees; at least two angled connectors interconnecting the base and the support structure; and releasable fasteners spaced along the support structure and each rear face, wherein grooves of the grooved face are at least bidirectional.

These and other features, aspects and advantages of the present invention will become better understood with reference to the following drawings, description and claims.

### BRIEF DESCRIPTION OF THE DRAWINGS

FIG. 1 is a front perspective view of an exemplary embodiment of the present invention, shown in use;

FIG. 2 is a front perspective view of an exemplary embodiment of the present invention;

FIG. 3 is a rear perspective view of an exemplary embodiment of the present invention;

FIG. 4 is an exploded front perspective view of an exemplary embodiment of the present invention;

FIG. 5 is a front perspective view of an exemplary embodiment of the present invention; and

FIG. 6 is a front perspective view of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a multi-panel scratching system for pets having a support structure transversely extending from a base structure. A plurality of releasable fasteners spaced apart along the support structure. A plurality of scratching panels also with releasable fasteners to removably and selectively connect to the support structure. Each scratching panel may provide a flat face, a grooved face, a cushioned face, a carpeted face or a combination thereof for pets to scratch.

Referring now to FIGS. 1 through 6, the present invention may include a multi-panel scratching system 100 for cats. The multi-panel scratching system 100 may provide an upper support structure 109 joined to a base 30 by one or more angular support 111 so that when the base 30 is lain on a flat supporting surface, such as the ground or a floor, the upper support structure 109 extends transversely from the flat supporting surface, in certain embodiments, at an angle of incidence. The upper support structure 109 typically has at least two vertical components.

The upper support structure 109 may be frame with spaced apart longitudinal members. A plurality of releasable fasteners 113 may be spaced apart so as to align along the opposing longitudinal members, as illustrated in FIG. 2. The present invention may include a plurality of panels, which may include but not be limited to a fabric cushion panel 101, a grooved face panel 103, a carpet panel 105, a flat face panel 107, a grooming panel 213, and a toy panel 203. Each panel may include second releasable fasteners for removably attaching to the first releasable fasteners 113 so that users can selectively add and arrange desired panels across the frame. In another arrangement, the vertical components of the upper support structure 109 may provide notches 120 that the panels 203 can be supported on either end and locked into place by on the frame by the user without the need for releasable fasteners.

For some panels, fabric may be stretched across the front of a wood panel, separated by fill, and attached to the back of the panel along the edges to form the cushiony sofa panel 101. In other arrangements, carpeting may be attached to the front of a panel with adhesive to form the carpet panel 105. Grooves may be cut into a panel to form the grooved panel 105. For some panels, toys 207, such as catnip filled mice, may be attached to the panels using a fastener such as Velcro, to provide the ability for the toys 207 to be removed by the cat. In other arrangements, bristles and other materials can be attached to a panel that provides a surface for cats to scratch themselves 213. 209 and 211 could be sisal-carpet type and cushion-type panels, respectively.

The panels may be made of wood, various plasticized materials, or the like. The panels may be attached to the upper support structure 109, and the multi-panel scratching system 100 may be placed in front of or in close proximity to a household object that cats like to scratch, but that the owner doesn't want the cat to scratch, or in front of an area or object to partially or completely block the access of that area or object from a cat. And, if the cat prefers to scratch wood, then one or more wood panels 107 can be attached to the upper support structure 109. Or, if the cat is scratching on a sofa, then one or more sofa panels 101 can be attached to the upper support structure 109. Likewise, if the cat enjoys scratching on carpet then one or more carpet panels 105 can be attached to the upper support structure 109.

The present invention can be placed in front of cabinets, wooden bed frames, doors, sofas, tables and other items that cats typically scratch. The panels of the present invention that the pet owner chooses to use can be those that mimic the surface of the area that is being protected. When the cat uses the present invention, the owner should praise the cat to reinforce the good behavior. Any combination of panels can be attached to the present invention to provide the cat a variety of scratching surfaces. The panels can be replaced with new panels when they become worn down, if the pet owner wants to use a more decorative panel, or if the pet owner wants to use a different type of panel surface.

The wood panels can be manufactured in the following way: For cats that like to scratch on wood, a wood panel 107 variation can have a series of low depth cuts from left to right to increase the amount of edges on the panel for the cat to scratch, which would amount to the grooved-face panel 103. It being understood that the grooved-face panel could have orthogonal or transverse oriented grooves relative to the left-to-right grooves. Carpet panels 105 can be constructed with a piece of carpet that is attached to the surface of a panel with an adhesive such as wood glue. Fabric cushion panel 101 can be constructed using a panel base. Fill material can be placed between the fabric and the panel face to form a cushion. The fabric can be attached to the back of the panel using a staple gun. The panel configuration on the present invention can have any combination of wood, fabric, carpet or panels with other surface materials cats enjoy scratching.

Additional surface materials could be added to panels such as pet toys, to make the invention more interesting to the desired pet. Cat nip spray can be applied to attract cats to the present invention when initially introducing the present invention to the cats. It is possible to achieve similar results with one larger replaceable panel. Each panel can include one or more surface types. For example, one panel could have both grooved cuts in the wood and an area for carpet.

It should be understood, of course, that the foregoing relates to exemplary embodiments of the invention and that modifications may be made without departing from the spirit and scope of the invention as set forth in the following claims.

What is claimed is:

1. A scratching panel system, comprising:
a support structure;
a plurality of panels, each panel having a rear face and a front face;
the rear face adapted to selectively and removably connect along the support structure;
the front face comprising:
(a) a planar face;
(b) a grooved face;
(c) a cushioned face;
(d) a carpeted face; or
(e) a combination of two or more of (a) through (d),
wherein the plurality of panels comprises at least two of (a) through (d).

2. The scratching panel system of claim 1, wherein the plurality of panels comprise at least at least three of (a) through (d).

3. The scratching panel system of claim 1, wherein each panel is made of wood.

4. The scratching panel system of claim 1, further comprising a base connected relative to the support structure at an angle of incidence between 65 and 35 degrees.

5. The scratching panel system of claim 4, further comprising at least two angled connectors interconnecting the base and the support structure.

6. The scratching panel system of claim 1, further comprising releasable fasteners spaced along the support structure and each rear face.

7. The scratching panel system of claim 1, wherein grooves of the grooved face are at least bidirectional.

8. The scratching panel system of claim 1, wherein the support structure is elongated having a length at least twice that of a width.

9. The scratching panel system of claim 1, wherein the plurality of panels comprise at least at least four of (a) through (d) and at least one (e).

10. A scratching panel system, comprising:
a support structure, wherein the support structure is elongated having a length at least twice that of a width;
a plurality of wood panels, each panel having a rear face and a front face;
the rear face adapted to selectively and removably connect along the support structure;
the front face comprising:
(a a planar face;
(b) a grooved face;
(c) a cushioned face;
(d) a carpeted face;
(e) a toy face; or
(f) a combination of two or more of (a) through (e),
wherein the plurality of wood panels comprises at least two of (a) through (d) and at least one (e);
a base connected relative to the support structure at an angle of incidence between 65 and 35 degrees;
at least two angled connectors interconnecting the base and the support structure; and
releasable fasteners spaced along the support structure and each rear face.

11. The scratching panel system of claim 10, wherein grooves of the grooved face are at least bidirectional.

12. The scratching panel system of claim 10, wherein the toy face comprised removably catnip toys.
